(19) United States
(12) Patent Application Publication
(10) Pub. No.: US 2002/0125365 A1
(43) Pub. Date: Sep. 12, 2002

(54) Personal flight system

(76) Inventor: David M. Urie, Anderson, CA (US)

Correspondence Address: Anglin & Giaccherini, Post Office Box 1146, Carmel Valley, CA, 93924, US

(21) Appl. No.: 09/802,754

(22) Filed: Mar. 9, 2001

(51) Int. Cl. B64C 1/00

(52) U.S. Cl. 244/4 A

(57) ABSTRACT

Methods and apparatus for providing a personal-scale wing which may be ridden by a skydiver during free fall are disclosed. Unlike previous surfboards or snowboards which have been adapted for use by skydivers, the present invention incorporates an airfoil which produces circulation lift. This lift-generating wing dramatically enhances the flight of the skydiver by enabling positive flight control and manueverability. The lift forces significantly counteract gravity, and extend the time of flight and ground track traveled by the skydiver. The present invention will expand the art of skydiving to a large number of sports enthusiasts around the world.

### FIELD OF THE INVENTION

The present invention pertains to methods and apparatus for providing an aerodynamic platform which provides lift for use by a skydiver. More particularly, one embodiment of the invention is an unpowered wing which extends perpendicular to the length of the human torso, and which enables flight control and maneuverability during free fall.

### BACKGROUND OF THE INVENTION

Skydivers have developed a number of devices that are used during a free fall after jumping from an aircraft. Over the years, various parachutes and modified flight suits have been used for jumps. Recently, divers have been begun to use conventional or modified surfboards and snowboards which are ridden with the diver standing in an upright position, as shown in FIGS. 1 and 2. These conventional boards, which may include spoilers or other enhancements, do nothing to improve the diver's flight control or maneuverability, since they only increase the drag on the diver. None of these previous devices generate lift which would increase the elapsed time of the descent, or the horizontal distance traveled during the jump, which is also called the “ground track.” The development of a device that would enhance the free fall of a skydiver by providing maneuvering and flight control would constitute a major technological advance, and would satisfy long felt needs and aspirations in the civil aviation industry.

### SUMMARY OF THE INVENTION

The Personal Flight System provides methods and apparatus for enabling a skydiver to control and enhance his or her descent from an aircraft. One preferred embodiment of the invention is a lightweight, and easy to handle wing with dihedrals extending from the wingtips. After jumping from an aircraft, the skydiver rides on top of the wing, which extends out perpendicular from the skydiver's body. The flight is controlled with simple body movements. While an unaided skydiver simply falls to Earth without generating any lift, the present invention utilizes an airfoil that produces circulation lift which adds maneuverability, endurance and range to the skydiver's descent. The airfoil utilized by one of the preferred embodiments not only generates relatively large lift forces, but also provides negative feedback mechanisms which discourage unwanted pitch and roll movements, insuring stable, level flight.

The present invention will provide a new vehicle for the skydiver, and will enable the expansion of the sport to a great number of sports enthusiasts.

An appreciation of the other aims and objectives of the present invention and a more complete and comprehensive understanding of this invention may be obtained by studying the following description of a preferred embodiment, and by referring to the accompanying drawings.

### A BRIEF DESCRIPTION OF THE DRAWINGS

FIGS. 1 and 2 are reproductions of photographs of skydivers in free fall with conventional boards attached to their feet.

FIG. 3 provides cross-sectional views of one embodiment of the present invention.

FIG. 4 is an illustration of one embodiment of the present invention being flown by a skydiver.

FIG. 5 illustrates a skydiver jumping from an aircraft with one embodiment of the present invention.

FIG. 6 reveals a series of charts which explain the details of the aerodynamic qualities of the human component of present invention.

FIGS. 7, 8, 9 and 10 furnish more technical details of the aerodynamics of the present invention. The graph shown in FIG. 7 plots lift values against flight range, the graphs in FIGS. 8 and 9 relate flight times with ground tracks, and FIG. 10 portrays curves that predict the stability of flight.

FIG. 11 includes diagrams which relate various leg positions of the skydiver to control capabilities for one embodiment of the present invention.

FIG. 12 reveals alternative wing configurations for the present invention.

FIG. 13 describes a “static stability margin” that quantifies the tendency of the wing to remain in stable flight.

FIGS. 14 and 15 show additional alternative embodiments of the invention.

FIG. 16 is a graph showing elapsed flight times versus ground tracks for various embodiments of the invention.

FIG. 17 is a graph which compares the cost per minute of flights for various embodiments of the invention.

FIG. 18 is a graph which illustrates the one year payback value of various embodiments of the invention.

### A DETAILED DESCRIPTION OF PREFERRED & ALTERNATIVE EMBODIMENTS

I. A Preferred Embodiment of the Invention

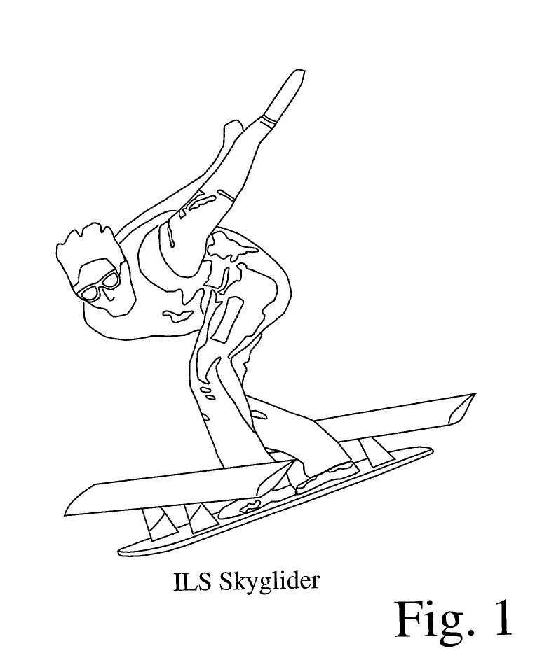

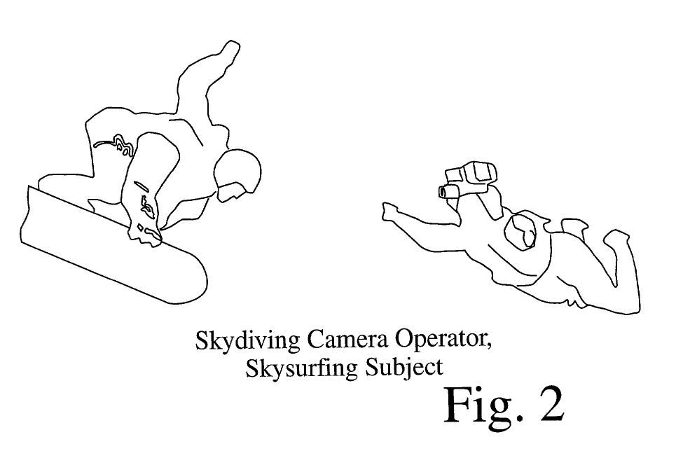

In the past, skydivers have utilized various items to modify their descent from an aircraft. FIGS. 1 & 2 depict skydivers using previous devices that resemble surfboards. These previous devices not only fail to produce lift, but add substantial quantities of drag forces. While these devices may retard the rate of the diver's fall, they offer no means for flight control or maneuverability, and fail to add any endurance or range to the diver's journey through the air. In general, the drag forces at work on a conventional skydiver are always greater than any lift forces. Specifically, conventional skydivers never exceed a “lift over drag ratio” of 0.7.

One of the preferred embodiments of the present invention comprises methods and apparatus for providing a lightweight, personal airfoil for a skydiver. In this Specification and in the Claims that follow, the term “airfoil” is intended to encompass any unpowered or powered device which generates lift as it moves through the air. The term “skydiver” is intended to include any person who jumps from an aircraft, vehicle or high altitude location, and then either flies through the air, and/or subsequently falls to Earth. The term “lift” refers to any force that opposes gravity that is produced by an airfoil, platform or wing.

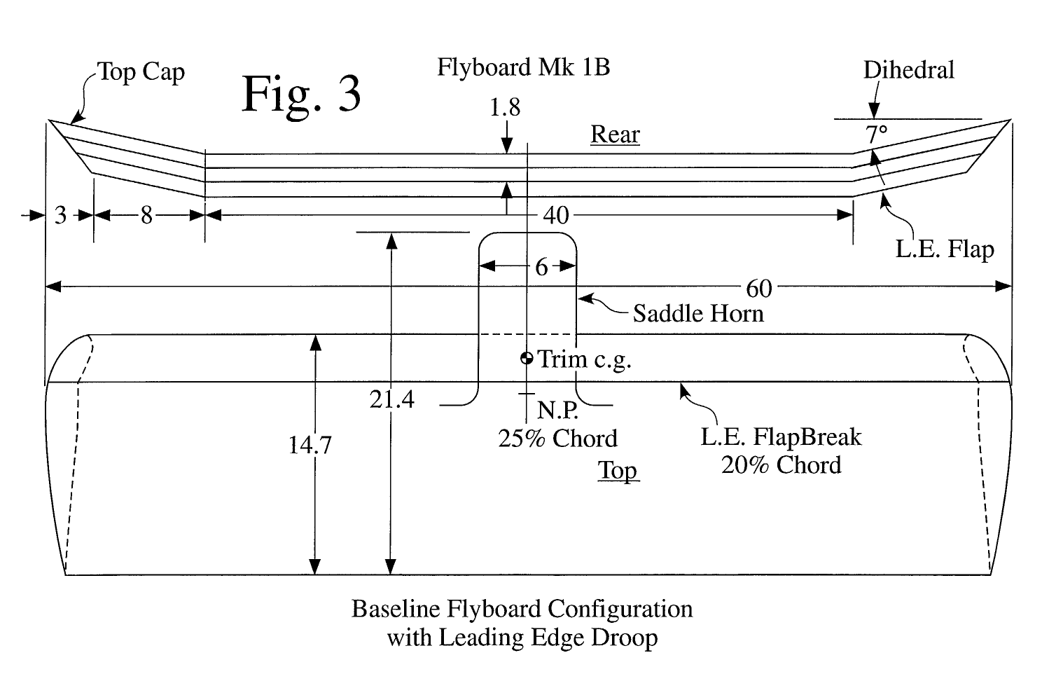

The primary objective of the invention is to furnish an aerodynamic means to enhance the experience of the skydiver by enabling control of the flight, and by extending the elapsed time of the jump. Extending the time of the jump also enables the skydiver to cover more distance over the Earth below, which is commonly called the “ground track” of the dive. One particular embodiment of the invention, which is illustrated in FIG. 3, is a molded plastic wing having an upper and a lower surface forming a lift-generating airfoil, measuring about five feet in wingspan. The width or “cord” of this wing extends less than two feet, and the thickness of the wing spans only a few inches. This embodiment is very smooth, strong, lightweight, relatively compact relative to the size of the skydiver, and is easily deployed as the diver departs from his or her aircraft at the beginning of the jump. This embodiment of the invention includes a pair of vertical structures called “dihedrals” which extend upward from the central body of the wing. In general, the longest dimension of the invention is sufficiently short to fit through the door of a conventional aircraft which is used for skydiving.

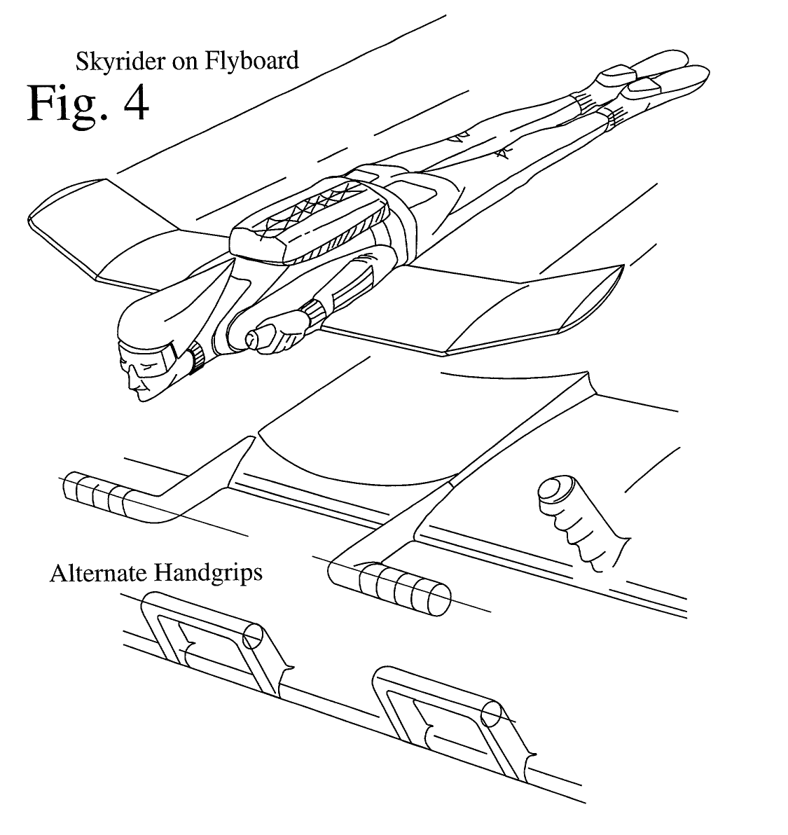

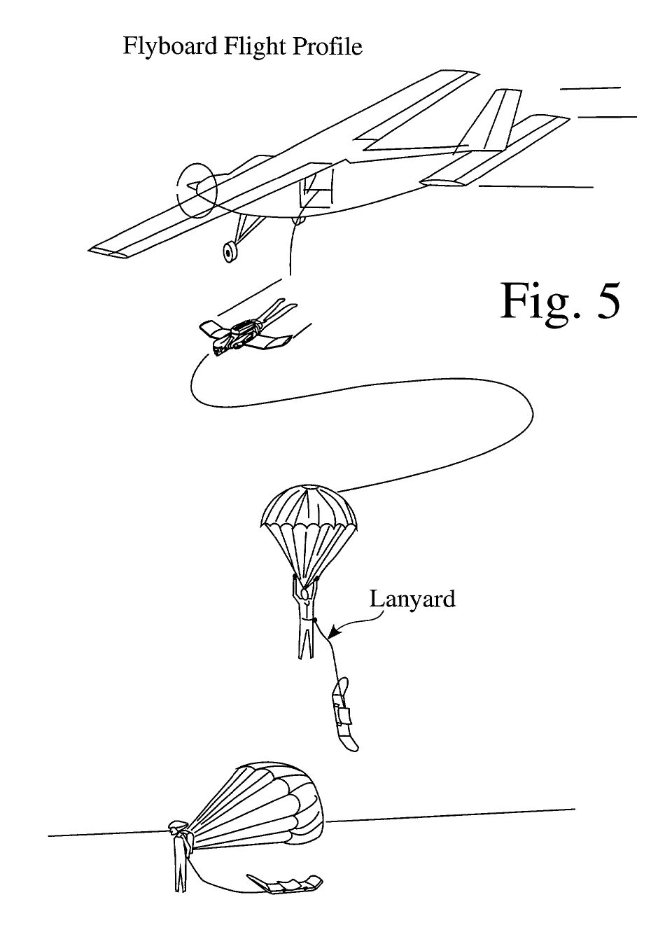

As shown in FIG. 4, the skydiver rides on top of this personalized wing, grasping handles or some other coupling or registration means which extend upward toward his body. The wing is generally operated in a plane extending parallel to the body of the skydiver. The optimal position of the skydiver relative to the wing requires that the skydiver's center of gravity be located slightly forward of the lift force produced by the wing, so that the wing is generally located below the skydiver's lower chest area. FIG. 5 shows the stages of a typical jump, from deplaning, to the operation of the invention, and then finally to the deployment of a parachute and the landing. FIG. 5 also illustrates a safety release which may be operated to separate the skydiver from the wing.

Unlike a conventional skydiver, who essentially presents a flat plate falling normal to the rush of air, the present invention utilizes an airfoil cross-section to generate circulation lift. Unlike a skydiver using a modified surfboard or snowboard, which does not improve the aerodynamics of a descent, the present invention changes the aerodynamics of the diver by incorporating a cross-sectional design which provides the maximum lift coefficient, enabling controlled flight.

In one particular embodiment, the airfoil employed by the present invention is characterized by a rounded leading edge, and a relatively sharp trailing edge. This design produces circulation lift as the wing moves through the air. The present invention contributes more lift forces than it adds in drag forces. In comparison to the unaided skydiver, who never exceeds a lift over drag ratio of 0.7, one of the preferred embodiments of the invention operates at a lift to drag ratio of 2.0.

In general, the invention encompasses any aerodynamic means, platform or vehicle which generates circulation lift to enable a controlled flight instead of a generally passive free fall. Unlike a conventional skydiver, who generally falls toward the Earth, the present invention permits a skydiver in free fall to achieve a glide slope of generally less than ninety degrees.

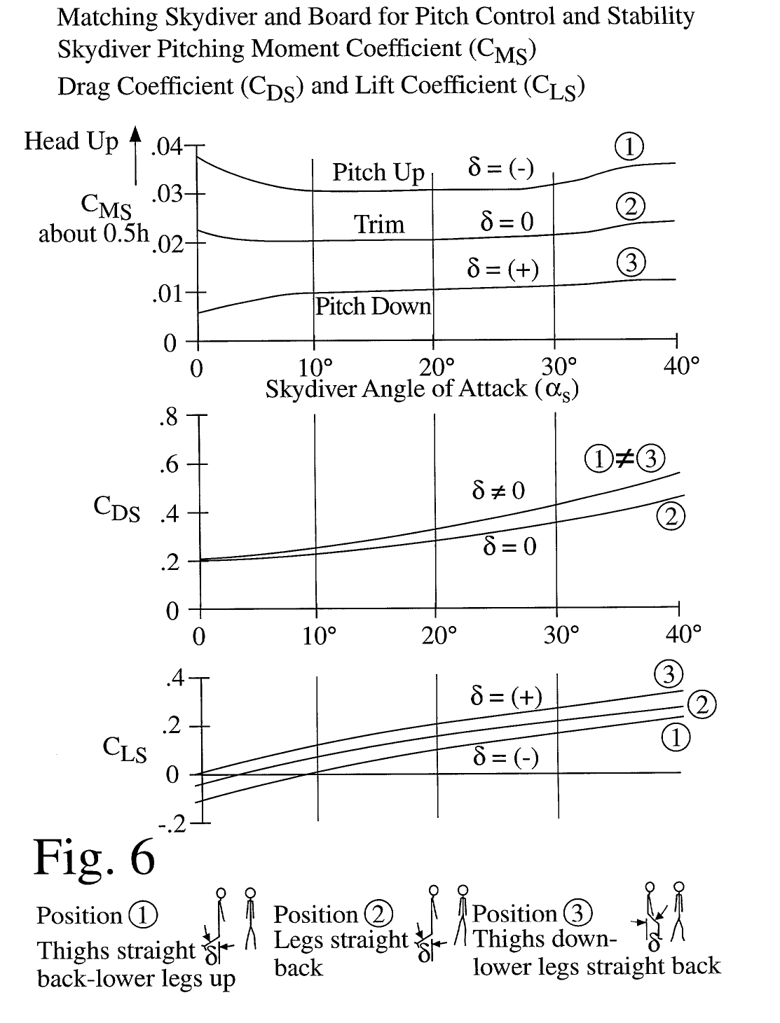

FIG. 6 furnishes graphs which plot pitching moment coefficient, lift coefficient and a drag coefficient of a human figure versus angles of attack. The present invention is designed to promote stable and level flight by incorporating design features which discourage unwanted pitch and roll movements. If the flying position of the wing is deflected so that its nose is pitched upward away from the ground, the physical configuration of the invention reacts by retarding the upward pitch and by restoring a level orientation. This “anti-pitching” feature is essentially a negative feedback phenomenon which may be technically described as a “neutral pitching moment” that counteracts any tendency of the wing torque or rotate up or down. Pitching moment values for various embodiments of the invention and different operating parameters are quantified in the graphs presented in FIG. 6. A preferred embodiment of the invention operates at a zero pitching moment while the wing is flying.

Just as undesirable pitching movements are damped, the invention also offers a negative feedback feature for unwanted roll movements. The dihedrals act as a vertical stabilizer means which extend from the ends of the wing tend to reduce rotation about the length of the skydiver, promoting stable flight.

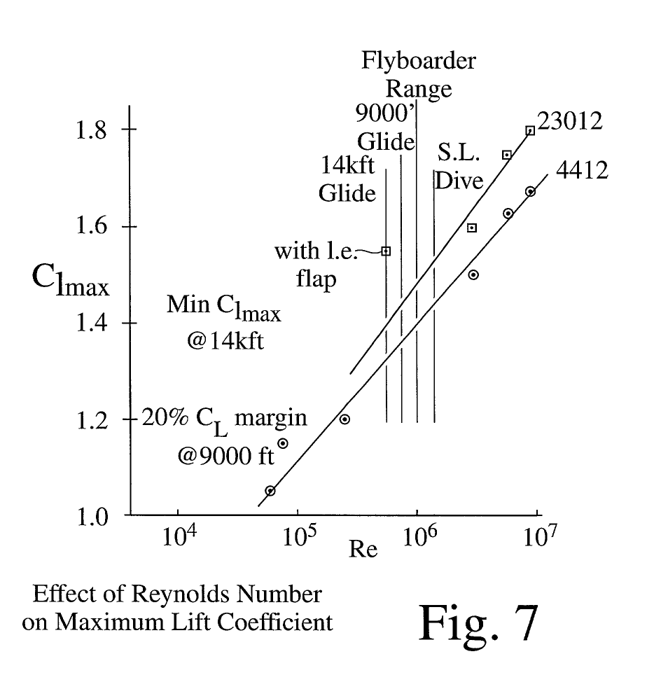

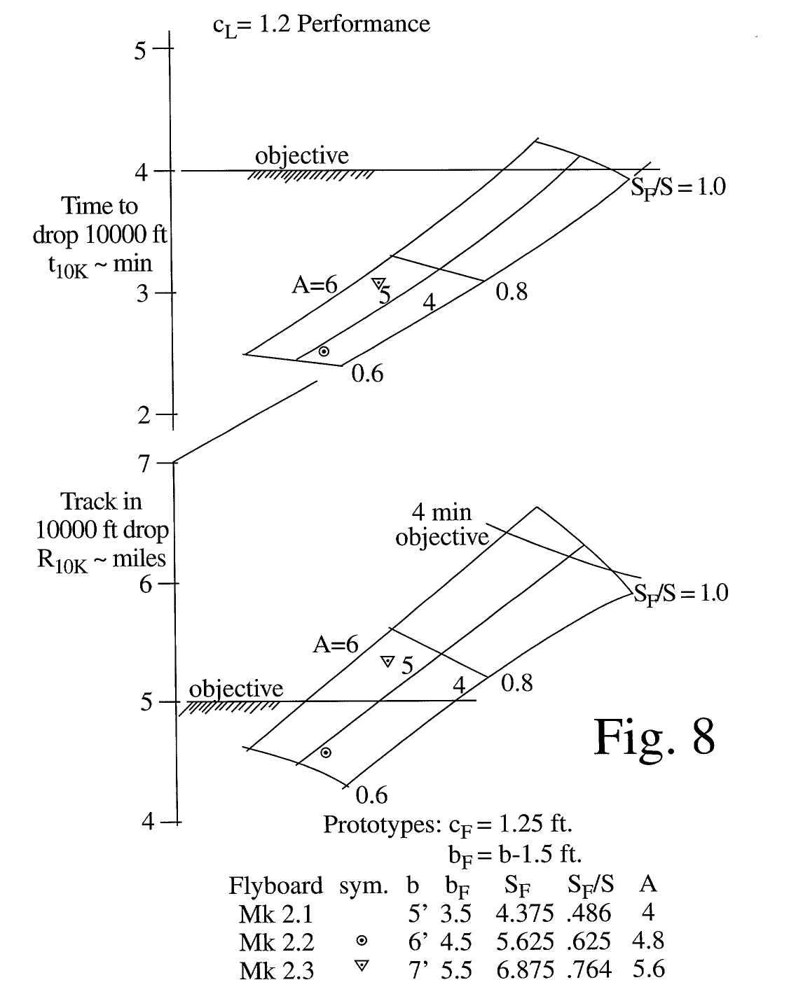

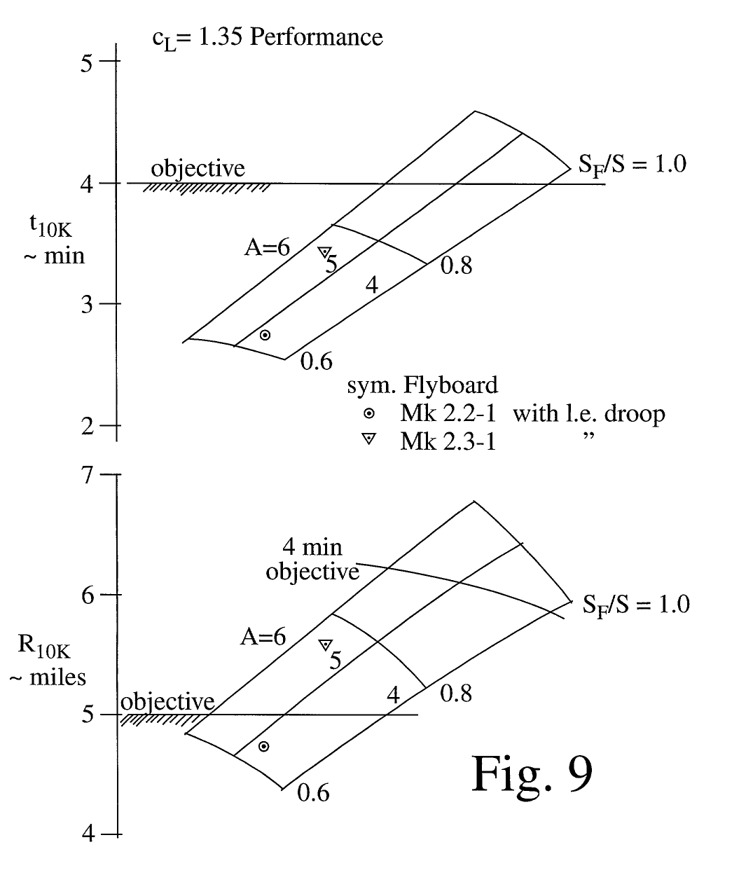

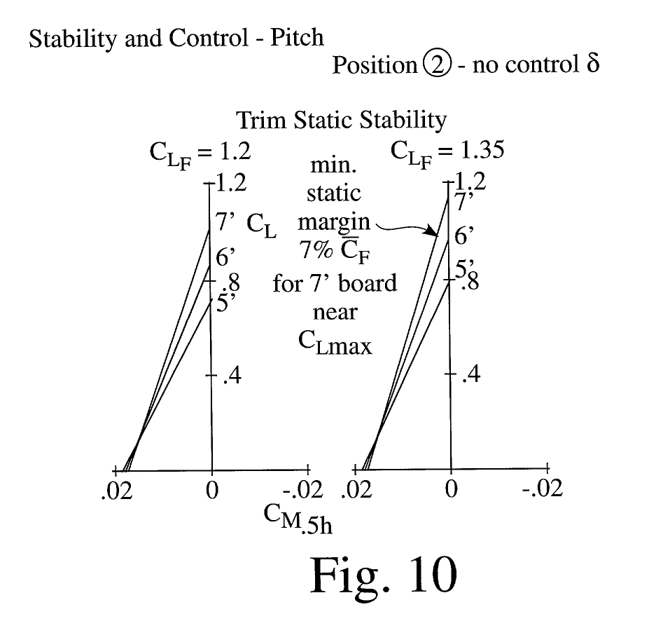

Additional technical details of the invention are presented in FIGS. 7 through 10. FIG. 7 supplies a graph which plots the effect of various Reynolds Numbers on maximum lift coefficients. FIGS. 8 and 9 offer diagrams which reveal the time to drop 10,000 feet, the ground track covered in a 10,000 foot drop for various lift coefficients. FIG. 10 presents graphs which describe the trim static stability of three embodiments of the present invention.

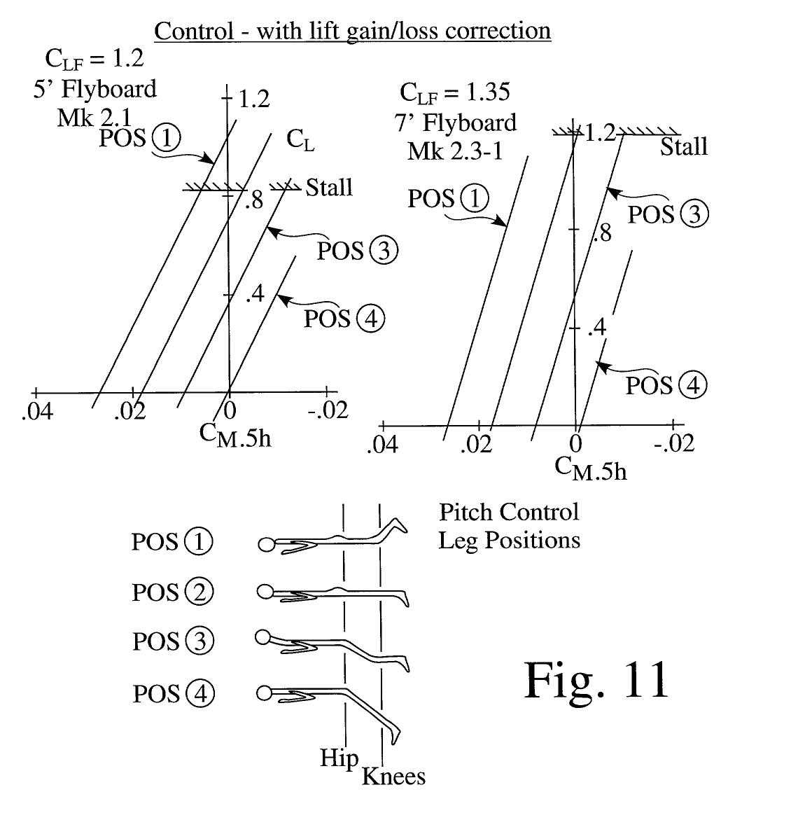

The flight of the present invention may be controlled by simple body movements. When the skydiver swings out an elbow, he changes the aerodynamics of the wing by producing roll forces, and a left or right turn is initiated. FIG. 11 includes diagrams which show how raising or dropping portions of the leg changes the pitch of the wing.

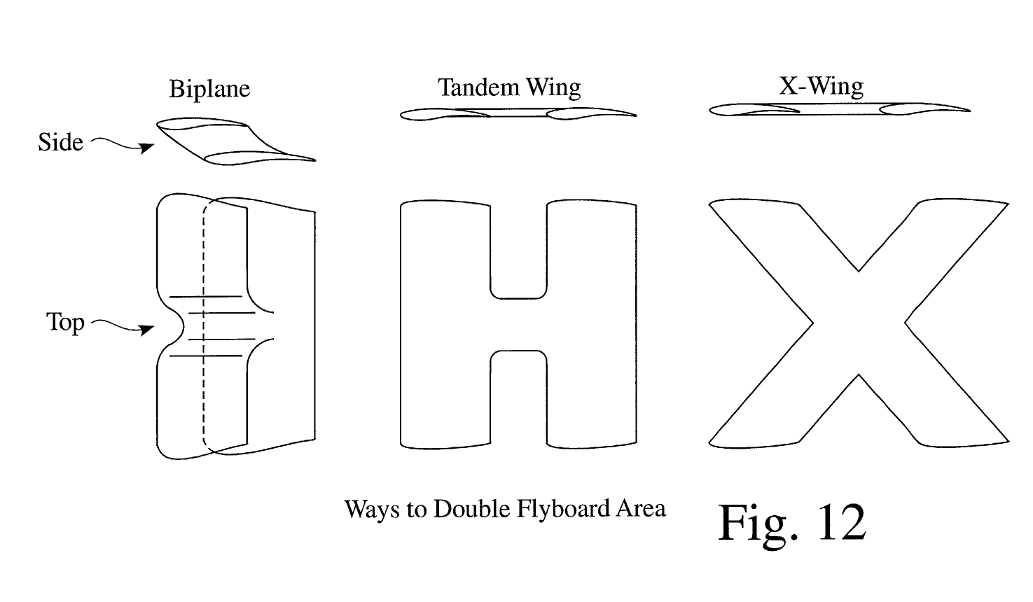

FIG. 12 reveals alternative configurations for the present invention, including biplanes, tandem “H” and “X” wings. These alternative embodiments of the invention supply increased wing area that, in turn, increases lift.

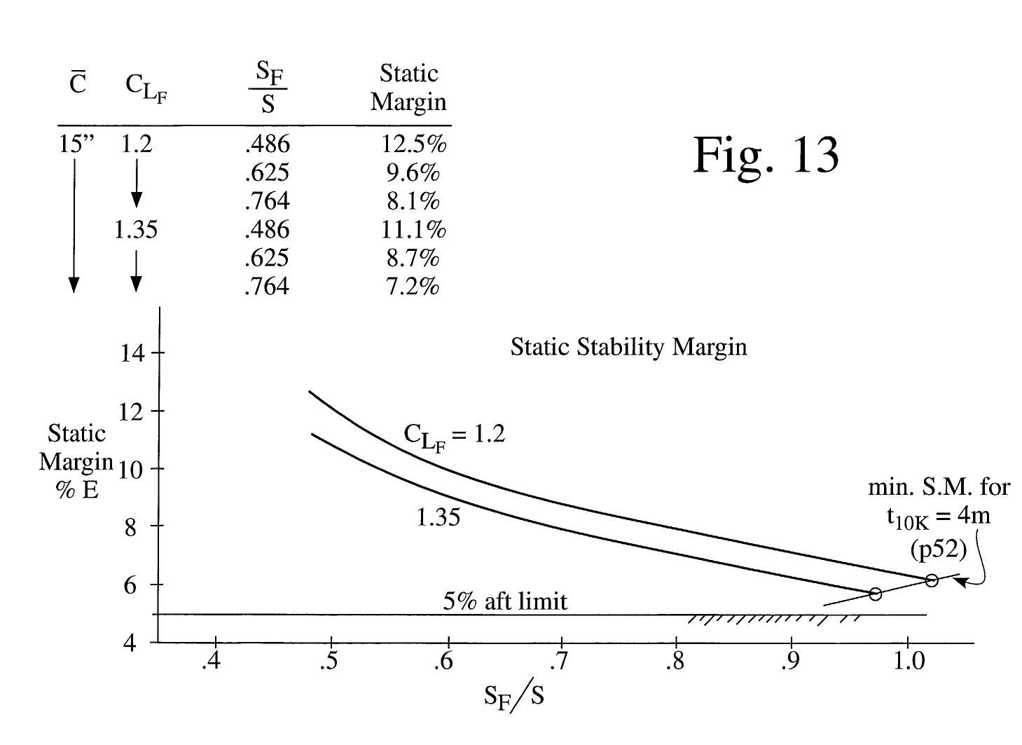

FIG. 13 describes a static stability margin which relates mathematical values for the stability and responsiveness of the wing in flight.

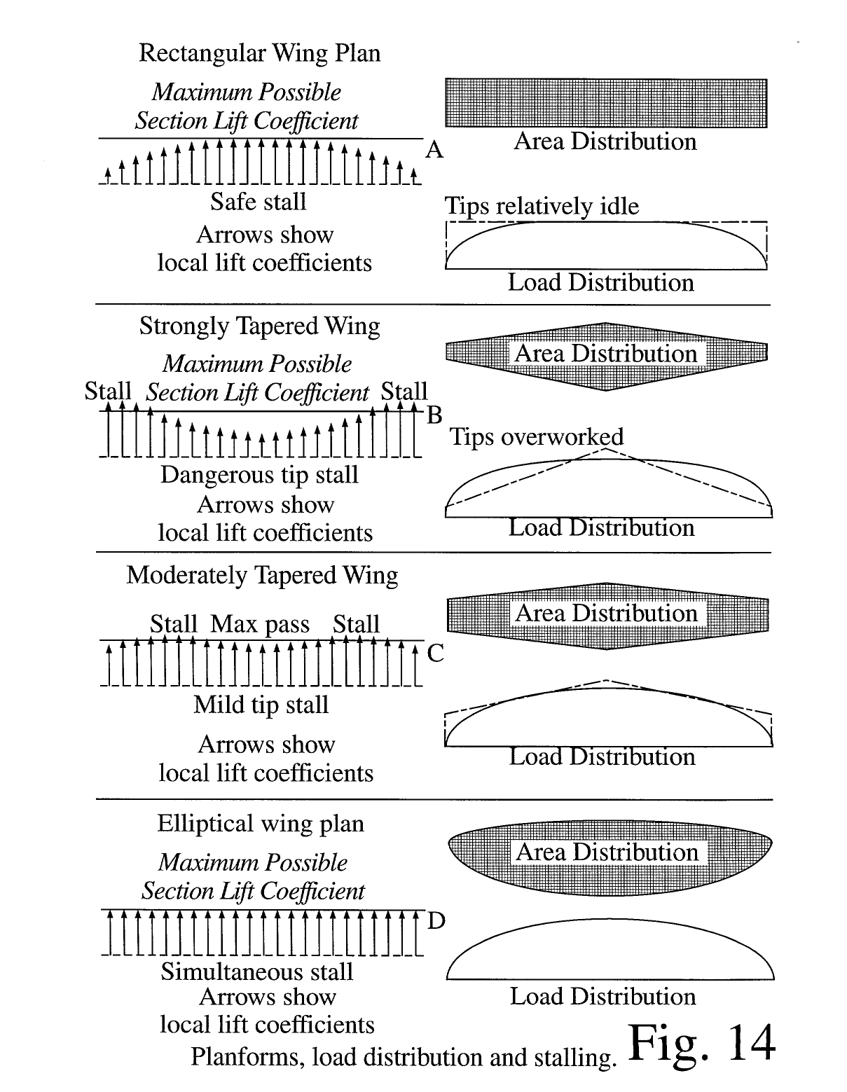

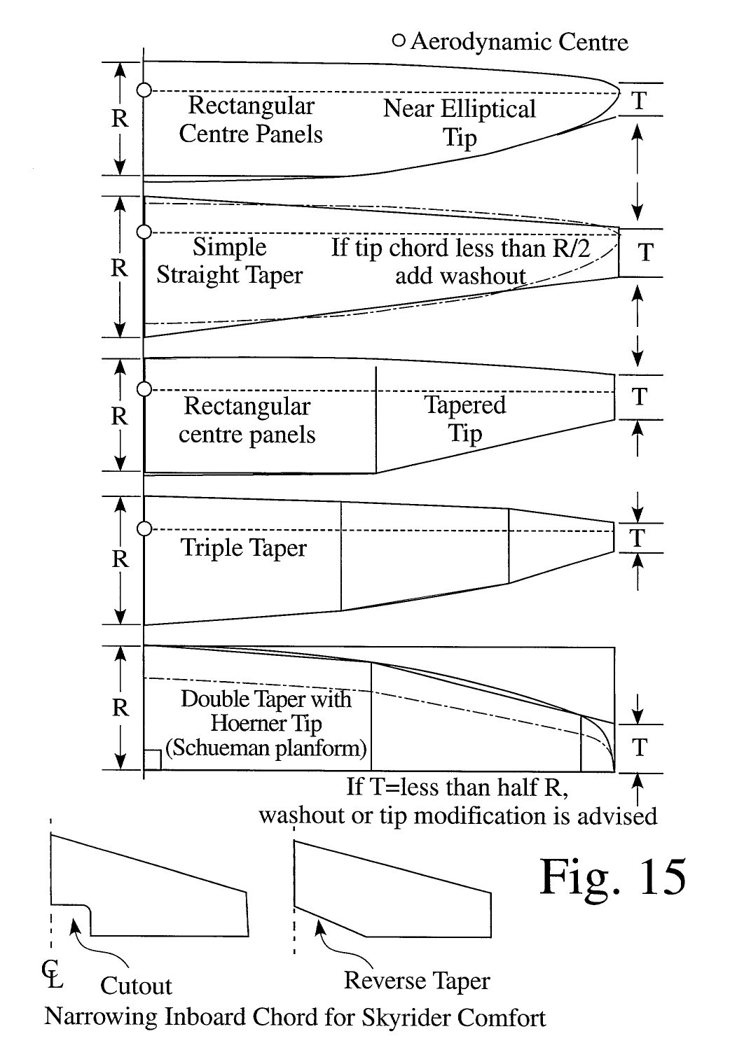

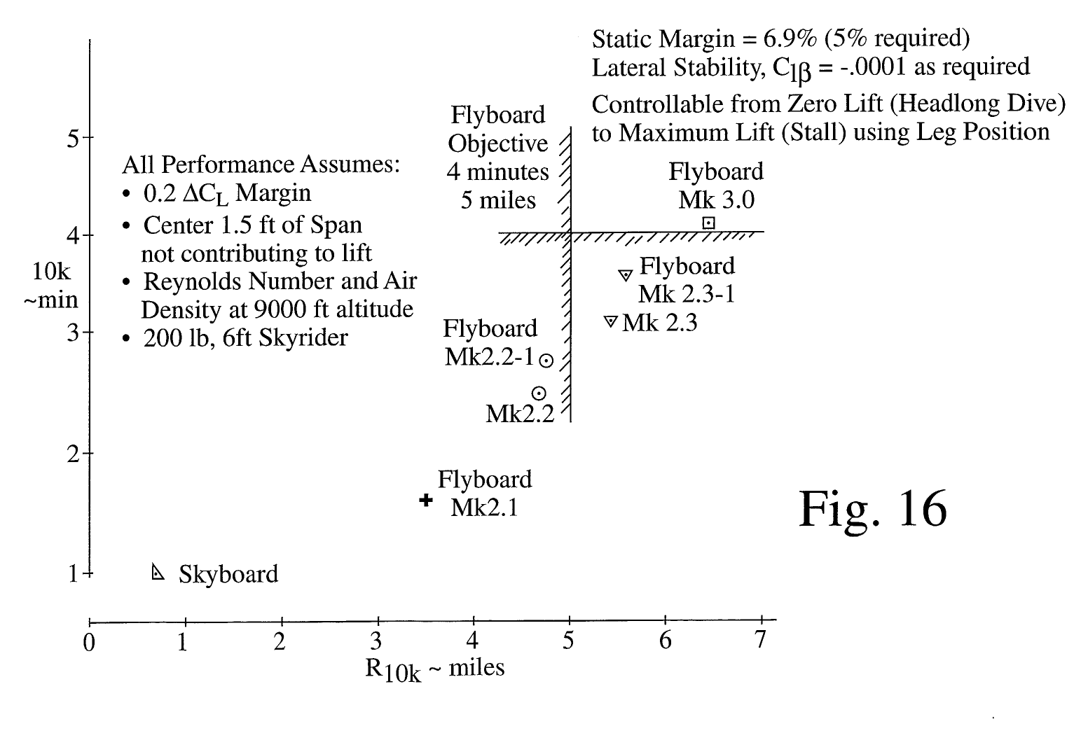

FIGS. 14 and 15 show additional alternative embodiments of the invention. In particular, these figures offer a variety of wing tapers and shapes that may be incorporated in alternative embodiments. FIG. 16 is a graph showing elapsed flight times versus ground tracks for various embodiments of the invention.

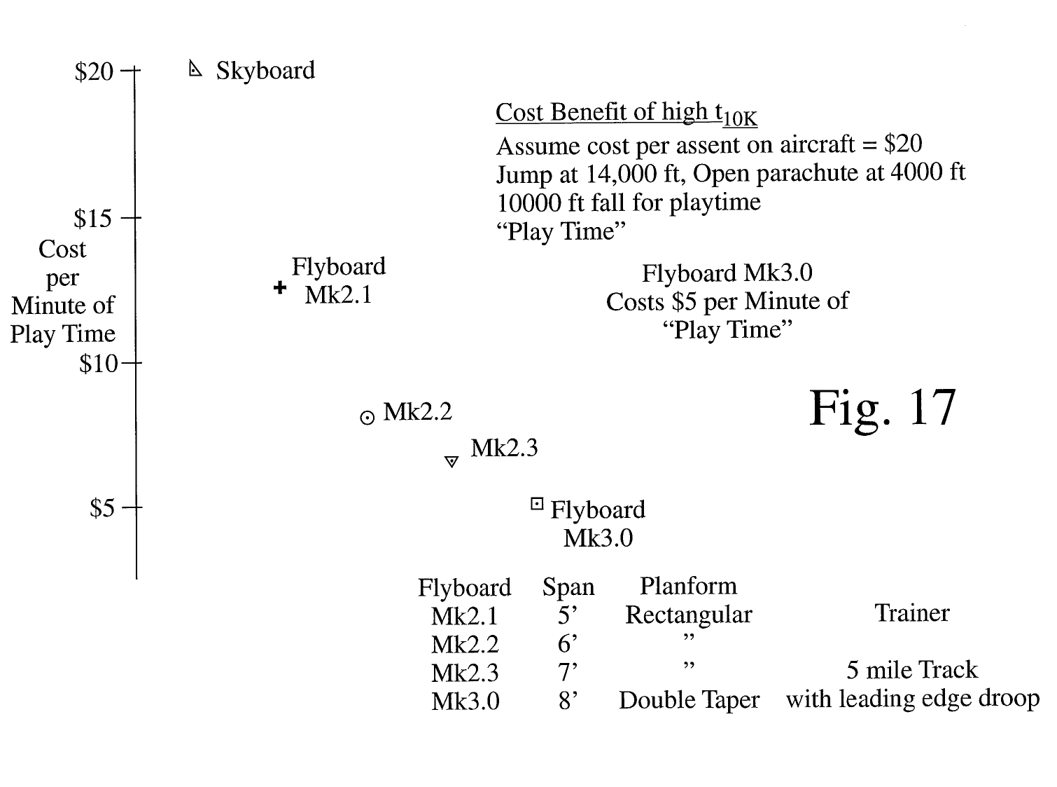

FIG. 17 is a graph which compares the cost per minute of flights for various embodiments of the invention.

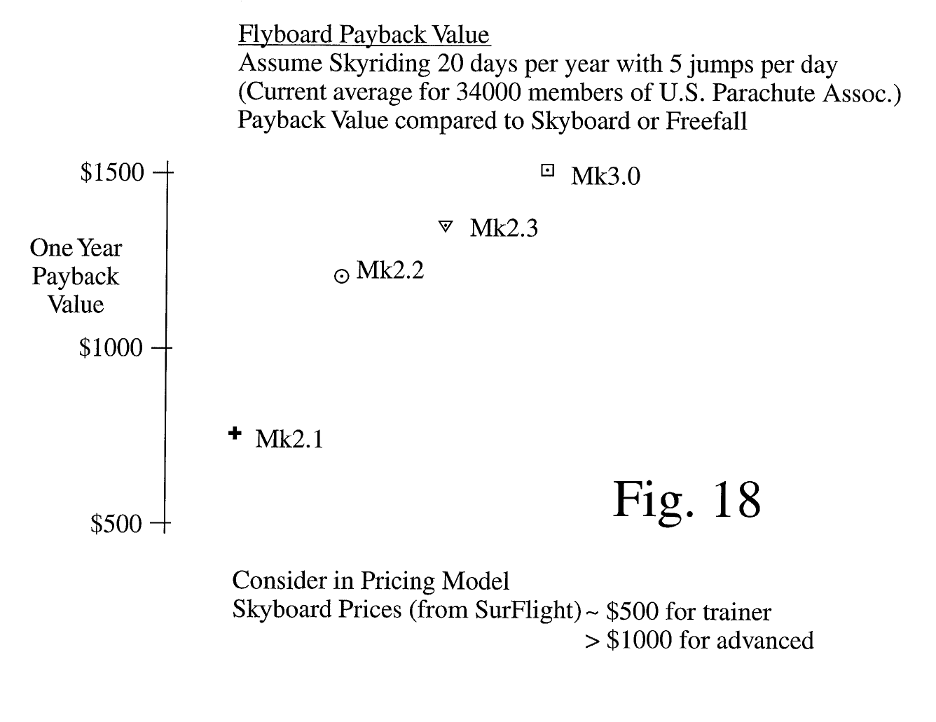

FIG. 18 is a graph which illustrates the one year payback value of various embodiments of the invention.

II. Alternative Embodiments of the Invention

Alternative embodiments of the invention may incorporate a wide variety of aerodynamic enhancements, including spoilers, flaps, trim devices, winglets that increase thrust, and vertical stabilizers that improve flight stability.

One manufacturing method that may be utilized to produce the invention is called “rotary molding,” and uses a generally hollow clamshell mold that is first filled with dry, encapsulated plastic resin, and then closed and rotated while it is heated.

In other embodiments, the invention may comprise the focus of a new form of skydiving resort. The invention may be implemented in a variety of unpowered or powered alternatives, and may also be utilized as unmanned vehicles or platforms. Miniature versions of the invention may also combined with various toys or action figures.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for providing aerodynamic platforms that have been disclosed above are intended to educate the reader about preferred embodiments of the invention, and are not intended to constrain the limits of the invention or the scope of Claims.

What is claimed is:

1. An apparatus comprising:
an aerodynamic platform means for enabling a controlled descent;
said aerodynamic platform means being adapted for use by a skydiver; and
said aerodynamic platform means being adapted for flight in a direction generally perpendicular to the extended length of said skydiver.

2. An apparatus as recited in claim 1, in which said aerodynamic platform means extends beyond the cross-section of said skydiver.

3. An apparatus as recited in claim 1, in which said aerodynamic platform means includes a handle means which maintains the proper registration of the relative positions of said platform means and said skydiver.

4. An apparatus as recited in claim 1, in which said aerodynamic platform means is adapted to be operated in a plane extending parallel to the body of said skydiver.

5. An apparatus as recited in claim 1, in which said aerodynamic platform means provides increased lift.

6. An apparatus as recited in claim 1, in which said aerodynamic platform means includes a vertical stabilizer means for damping unwanted roll movements.

7. An apparatus as recited in claim 1, in which said aerodynamic platform means is sufficiently short to fit through the door of a conventional aircraft.

8. An apparatus as recited in claim 1, in which said skydiver rides on the upper surface of said aerodynamic platform means while said aerodynamic platform means is positioned near the skydiver's lower chest.

9. An apparatus as recited in claim 1, in which said aerodynamic platform means produces a lift vector during flight, and is operated such that the center of gravity of said skydiver is slightly forward of said lift vector.

10. An apparatus as recited in claim 1, in which said aerodynamic platform means includes a safety release which may be operated by said skydiver to separate said skydiver from said aerodynamic platform means.

11. An apparatus as recited in claim 1, further comprising a winglet to increase thrust.

12. An apparatus as recited in claim 1, further comprising a vertical stabilizer to enhance flight stability.

13. An apparatus as recited in claim 1 which is manufactured from a plastic using rotary molding.

14. An apparatus comprising:
a skydiver wing means for facilitating airborne maneuvering;
said skydiver wing means being configured to provide negative feedback to maintain stable flight.

15. An apparatus comprising:
a skydiver wing means for facilitating airborne maneuvering;
said skydiver wing means having an upper and a lower surface;
said upper and said lower surface being configured to produce lift to increase the flight time of a skydiver.

16. An apparatus comprising:
a skydiver wing means for facilitating airborne maneuvering;
said skydiver wing means being characterized by a lift to drag ratio of generally greater than 0.7.

17. An apparatus comprising:
a skydiver wing means for facilitating airborne maneuvering;
said skydiver wing means being characterized by a maximum lift coefficient.

18. An apparatus comprising:
a skydiver wing means for facilitating airborne maneuvering;
said skydiver wing means being characterized by a generally neutral pitching moment.

19. An apparatus comprising:
a skydiver wing means for facilitating airborne maneuvering;
said skydiver wing means affording roll control through the movement the arms of the skydiver.

20. An apparatus comprising:
a skydiver wing means for facilitating airborne maneuvering;
said skydiver wing means affording pitch control through the movement the legs of the skydiver.

21. An apparatus comprising:
a skydiver wings means for facilitating airborne maneuvering;
said skydiver wing means configured to enable a skydiver in free fall to achieve a glide slope of generally less than ninety degrees.

22. A method comprising the steps of:
providing an aerodynamic platform for a skydiver; and
operating said aerodynamic platform in a controlled flight in a direction generally perpendicular to the extended length of said skydiver.

23. A method comprising the steps of:
providing a skydiver wing for facilitating airborne maneuvering; and
operating said aerodynamic platform in a controlled flight which provides negative feedback to maintain stable flight.

24. A method comprising the steps of:
providing a skydiver wing for facilitating airborne maneuvering; said skydiver wing having an upper and a lower surface;
producing lift during a free fall to increase the flight time of a skydiver.

25. A method comprising the steps of:
providing a skydiver wing for facilitating airborne maneuvering;
operating said skydiver wing at a lift to drag ratio of generally greater than 0.7.

26. A method comprising the steps of:
providing a skydiver wing for facilitating airborne maneuvering;
operating said skydiver wing during a free fall at a maximum lift coefficient.

27. A method comprising the steps of:
providing a skydiver wing for facilitating airborne maneuvering;
operating said skydiver wing during a free fall at a generally neutral pitching moment.

28. A method comprising the steps of:
providing a skydiver wing for facilitating airborne maneuvering;
controlling the roll of said skydiver wing during a free fall said skydiver wing by the movement of the arms of the skydiver.

29. A method comprising the steps of:
providing a skydiver wing for facilitating airborne maneuvering;
controlling the pitch of said skydiver wing during a free fall said skydiver wing by the movement of the legs of the skydiver.

30. A method comprising the steps of:
providing a skydiver wing for facilitating airborne maneuvering;
achieving a glide slope during a free fall of generally less than ninety degrees.

31. A method comprising the steps of:
falling from a location above the ground; and
riding a wing which generally extends at a right angle to the length of the rider which generates circulation lift.

32. A method comprising the steps of:
falling from a location above the ground; and
riding a wing which operates at a lift to drag ratio of greater than two.

33. A method comprising the steps of:
falling from a location above the ground; and
riding a wing which is characterized by a minimal pitching moment during flight.
